(19) United States
(12) Patent Application Publication
(10) Pub. No.: US 2014/0066023 A1
(43) Pub. Date: Mar. 6, 2014

(54) AUDIO FILE OR VOICE MESSAGE DELIVERY SYSTEM AND METHOD OF DELIVERING

(71) Applicant: AUDIO OPS, LLC, Sunbury, PA (US)

(72) Inventor: Sean M. PURDY, Sunbury, PA (US)

(73) Assignee: AUDIO OPS, LLC, Sunbury, PA (US)

(21) Appl. No.: 14/018,067

(22) Filed: Sep. 4, 2013

Related U.S. Application Data
(60) Provisional application No. 61/697,018, filed on Sep. 5, 2012.

(51) Int. Cl. H04M 3/533

(52) U.S. Cl. CPC H04M 3/533
USPC 455/412.1

(57) ABSTRACT

Provide is an audio file delivery system and a method of delivering an audio file. The system and method include a recording device, a wireless device, a job creation process, a job execution process, a telecom gateway and email verification. The job creation process is operable to receive instructions from the wireless device and communicate with a server. The job creating process creates a new job, the new job being operable to receive the audio file. The job execution process executes instructions on the server from the new job. The telecom gateway that receives input from the server and sends the audio file to at least one recipient telephone number. The email verification is provided by the server and sent to a user indicating that the audio file was received by a recipient.

### CROSS-REFERENCE TO RELATED APPLICATIONS

This patent application claims the benefit of U.S. Provisional Patent Application Ser. No. 61/697,018 filed on Sep. 5, 2012, entitled “AUDIO FILE OR VOICE MESSAGE DELIVERY SYSTEM AND METHOD OF DELIVERING” the disclosure of which is incorporated by reference as if fully rewritten herein

### FIELD OF THE INVENTION

This invention relates to telephony, and more particularly, to an audio file or voice message delivery system and method for delivering the audio file or voice message to a recipient or group of recipients.

### BACKGROUND OF THE INVENTION

Management of various projects and activities such as business projects and social activities often requires coordination of groups of associated individuals. Communication of messages may be accomplished through various media, e.g., telephone, email, text message, radio and other communication means. The coordination of such activities can be difficult to schedule and carry out to ensure that information is communicated timely to the correct individuals.

In most instances, job coordination is done using various calendar or docketing tools that then require creation of a new message or re-transmission of a previous message. Computer based messaging services are extremely time consuming and operate on platforms that usually require training to use. Using a computer or land line based messaging system requires that a user is tied to a desk or office, which is not always available. There is a need for a mobile system that allows a user to generate instruction messages and save the messages in a system that allows advance scheduling and automatic broadcasting of messages to one or more designated recipients.

Accordingly, it is an object of the invention to provide an audio file or voice message delivery system and method for delivering that do not suffer from the above drawbacks in the art.

### SUMMARY OF THE INVENTION

According to an exemplary embodiment of the present disclosure, an audio file or voice message delivery system is provided. The system includes a recording device operable to record an audio file(s) or voice message(s) and a wireless device having Internet connectivity. The system includes a job creation process operable to receive instructions from the wireless device and communicate with a server. The system includes a job execution process to execute instructions on the server from the job creation process. The system includes a telecom gateway that receives input from the server to send the audio file(s) or voice message(s) to at least one recipient telephone number. The system includes an email verification, wherein the email verification is provided by the server and sent to a user indicating that the audio file or voice message was received by a recipient.

According to another exemplary embodiment of the present disclosure, a method of delivering an audio file is provided. The method includes recording the audio file using a recording device. The method includes providing a wireless device having internet connectivity. The method includes accessing a job creation process with the wireless device, the job creation process being operable to receive instructions from the wireless device and communicate with a server, the job creation process including a new job. The method includes uploading the audio file to the new job. The method includes entering at least one recipient phone number on the wireless device, wherein the at least one recipient phone number is associated with the new job. The method includes running a job execution process, the job execution process being operable to execute instructions on the server from the new job created in the job creation process. The method includes sending the instructions and the new job from the server to a telecom gateway, the telecom gateway being operable to receive input from the server to send the audio file to the at least one recipient telephone number. The method includes sending the audio file to the at least one recipient telephone number through the telecom gateway. The method includes generating a report verifying delivery of the audio file to the at least one recipient telephone number.

According to yet another exemplary embodiment of the present disclosure, a method of delivering an audio file is provided. The method includes providing a wireless device having internet connectivity, the wireless device being operable to record and store the audio file. The method includes recording and storing the audio file on the wireless device. The method includes accessing a job creation process with the wireless device, the job creation process being operable to receive instructions from the wireless device and communicate with a server, the job creation process including a new job. The method includes uploading the audio file to the new job. The method includes entering at least one recipient phone number on the wireless device, wherein the at least one recipient phone number is associated with the new job. The method includes running a job execution process, the job execution process being operable to execute instructions on the server from the new job created in the job creation process. The method includes sending the instructions and the new job from the server to a telecom gateway, the telecom gateway being operable to receive input from the server to send the audio file to the at least one recipient telephone number. The method includes sending the audio file to the at least one recipient telephone number through the telecom gateway. The method includes generating a report verifying delivery of the audio file to the at least one recipient telephone number.

One advantage of an embodiment of the present disclosure is that audio files or voice messages created on cell telephones can be sent to landline telephones and cell telephones.

Yet another advantage of an embodiment of the present disclosure is that pre-recorded messages may be saved and transmitted to many recipients at pre-arranged times.

Another advantage of an embodiment of the present disclosure is a system and method that provides cost and time savings in sending audio file(s) or voice messages(s).

Yet another advantage of an embodiment of the present disclosure is a system that allows voice messages to be calendared and sent simultaneously to many recipients.

Another advantage of an embodiment of the present disclosure is a system that allows a user to categorize the audio file(s) or message(s) as a priority, as a business matter, as a personal matter, or as a family matter.

Yet another advantage of an embodiment of the present disclosure is a system and method that allows for a direct send function for immediate audio file or message processing.

Another advantage of an embodiment of the present disclosure is a system that adjusts the send time of audio files or voice messages to accommodate for different time zones of the intended recipients.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic context diagram of a voice message delivery system in accordance with an exemplary embodiment.

FIG. 2 is a schematic block diagram of a user registration process in accordance an exemplary embodiment.

FIG. 3 is a schematic block diagram of a job creation process of the present disclosure.

FIG. 4 is a schematic block diagram of a job execution process of the present disclosure.

Wherever possible, the same reference numbers will be used throughout the drawings to represent the same parts.

### DETAILED DESCRIPTION OF THE INVENTION

Provided is an audio file or voice message delivery system and method for distributing the recorded audio file or voice message to a number of recipients.

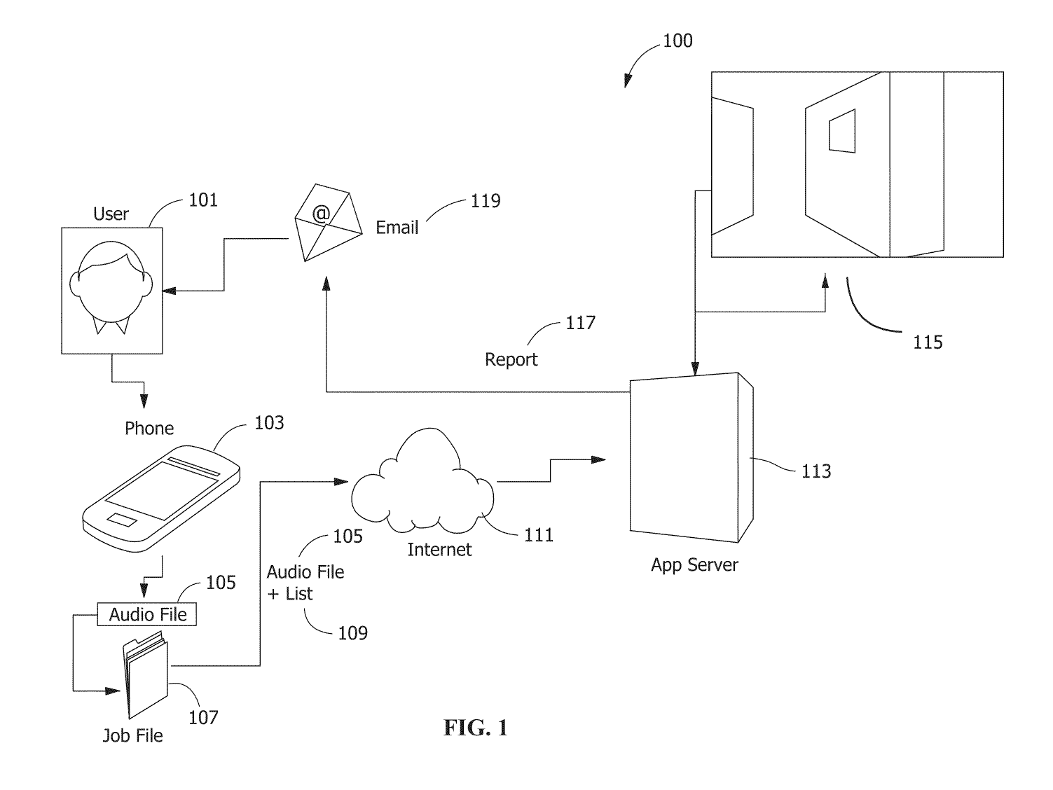

According to one embodiment, an audio file or voice message delivery system and method for delivering allows a user to send to at least one designated or desired recipient telephone an audio file or voice message. As used herein “telephone” may include any landline telephone or wireless telephone, such as a mobile cellular telephone or a smart phone, i.e., a device that enabled for telephone calls, with functions such as e-mail, text messaging and other data functions. FIG. 1 is a schematic context diagram of an audio file or voice message delivery system 100, hereinafter referred to as an “audio file delivery system,” for a user 101 to transmit an audio file 105. Audio file 105 may store digital audio data recorded or uploaded by user 101 and may be in compressed, lossless compressed or lossy compressed audio file format. Suitable examples of file extension for audio file 105, may include, but are not limited to, WAV, AIFF, MP3, WMA, APE or WV. Audio file 105 may contain a recorded voice message from a user 101, e.g., instructions to recipients of a message related to processing a job or event. Audio file 105 is intended to be sent to one or multiple recipients as designated by user 101.

As shown in FIG. 1, audio file delivery system 100 includes a wireless device 103 that allows user 101 to create or upload audio file 105 to a job file 107 configured by user 101 on wireless device 103. As used herein, “wireless device” includes mobile telephones, personal digital assistants (PDAs), smart telephones, tablets, laptop computers, and other wireless devices having GPRS, 3G, 4G, Wi-Fi or other wireless data connectivity. In one embodiment, not shown in the figures, user 101 may use any recording device, such as, but not limited to, digital recorders, microphones, landline telephones, desktop computers, or other means to create and upload audio file 105 to job file 107. In one embodiment, wireless device 103 may include the recording device, such as a microphone or digital recorder. User 101 uploads or transmits audio file 105 to job file 107. Job file 107 may be stored on wireless device 103 or remotely, e.g., on a server accessible by data link by wireless device 103. In one embodiment, wireless device 103 is used to record audio file 105 and used to process job file 107. Job file 107 receives and stores audio file 105 and a recipient list 109 containing recipients intended by user 101 to receive audio file 105. Audio file 105 and recipient list 109 are transmitted via the Internet 111 from job file 107 to an application server 113. Application server 113 is configured for two-way data communication with a telecom gateway 115 to transmit audio file 105 to telephone devices associated with each recipient on the user-designated list of recipients 109. Telecom gateway 115 records transaction data associated with each audio file transmission indicating, e.g., whether the call was received by the telephone number provided in recipient list 109 or if the call bounced. Telecom gateway 115 transmits data to application server 113, the data including a status report on all audio file transmissions to recipients 109. Application server 113 generates a report 117 on the data received from telecom gateway 115 regarding the distribution of audio file 105. Report 117 is transmitted by email 119 to the user 101.

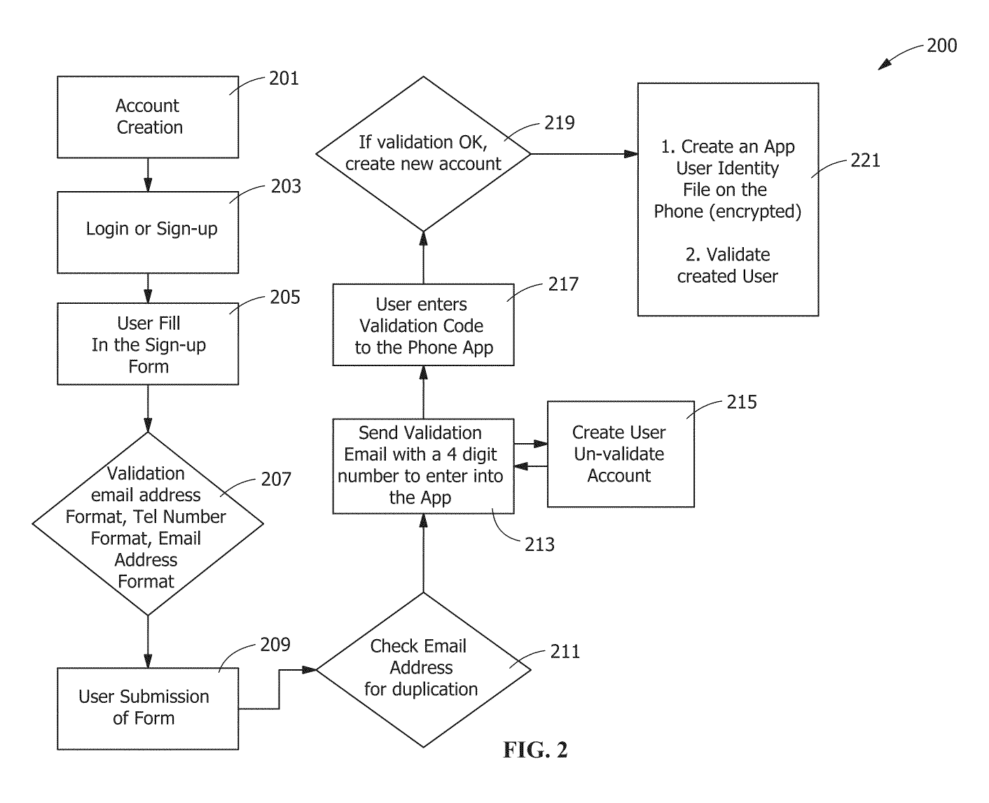

According to one embodiment, audio file delivery system 100 may include a user registration process that occurs prior to user 101 transmitting an audio file. FIG. 2 is a schematic block diagram of a user registration process 200 in accordance an exemplary embodiment. Registration is required of all users 101. Following initial registration, user 101 may be required to login to confirm a valid account exists for the respective user 101. The user registration process 200 includes creating an account by user 101 at step 201. Any mobile device or computing device with access to the Internet or an associated network 111 may be used to create a user account. During the step of account creation, step 201, user 101 logs in, if previously registered, or user 101 registers a new account at step 203. User 101 enters personal data in a registration or sign-up form at step 205 during an initial registration, or alternately, if previously registered, may change login parameters such as password or user information. User registration process 200 embedded within audio file delivery system 100 validates the format of the email address entered by user 101 and telephone number(s) entered by user 101 at step 207. User 101 submits the registration form at step 209 to application server 113. Application server 113 replies back to the email address provided by user 101 for approval and confirmation of the account. Once approved, application server 113 and wireless device 103 recognize user 101 as a client for the software application. In one embodiment, the entire process of account creation takes about 3 minutes from start to finish. User registration process 200 embedded within audio file delivery system 100 checks a user database on application server 113 for email addresses entered by user at step 211. If the new email address entered by the user is not a duplicate, registration process 200 embedded within audio file delivery system 100 proceeds to step 213 to generate a validation email with code, e.g., a four digit number, to the email address entered by user 101. Next, if the email submitted by user 101 during registration is a duplicate of an existing user account, an un-validated user account is created at step 215. Alternately, user registration process 200 embedded within system 100 may generate an error message to user 101 and request user 101 to enter another email address. User 101 enters the 4 digit number as a validation code into the software application at step 217. If the validation code entered into the software application is correct, then a new account is created for the software application at step 219. Once a new user account is created, user 101 may create an encrypted software application user identity file on wireless device 103 at step 221. Also at step 221, the software application cross references existing user identity files on application server 113 to verify that the selected user identity file is unique, and validates the newly created user.

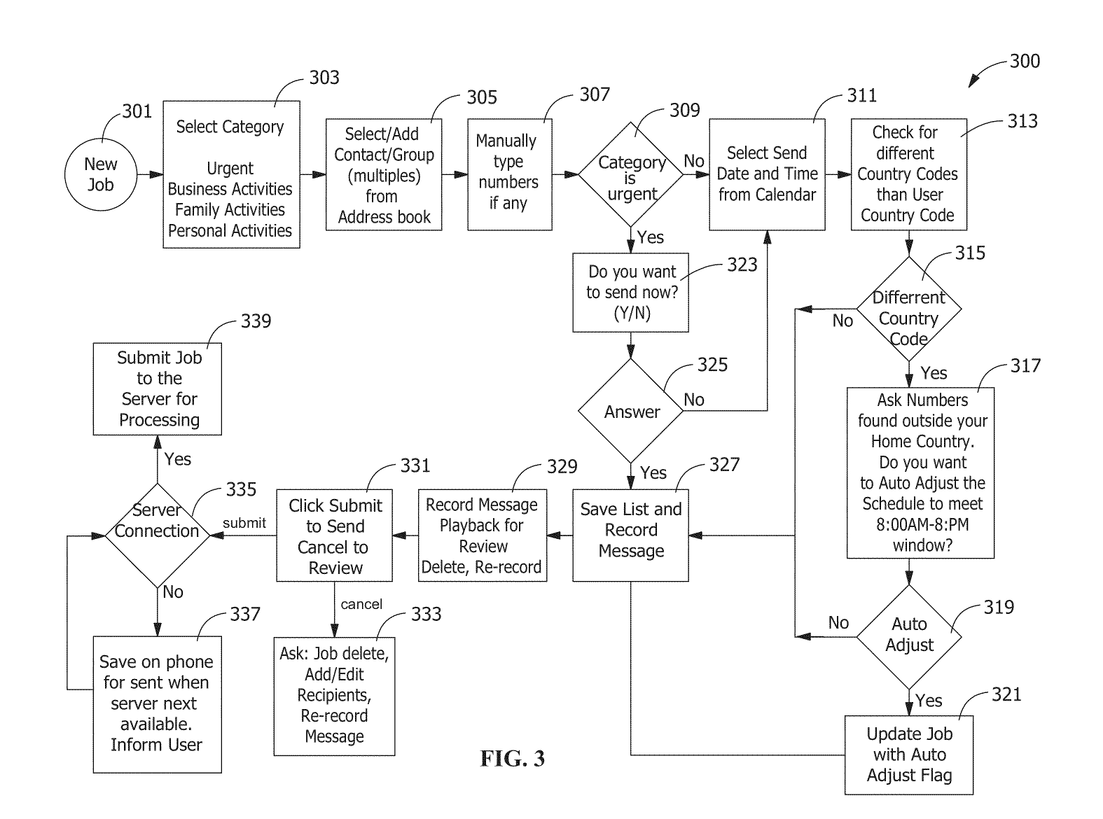

According to one embodiment, the audio file or voice message delivery system 100 includes a job or instruction creation process. FIG. 3 is a schematic block diagram of a job creation process 300 in accordance with an exemplary embodiment. As used herein, “job” is any set of instructions that is created by user 101 using the software application, those instructions later being used by application server 113. Job creation process 300 includes creating a new job or instruction, step 301. User 101 determines or selects a category for the new job or instruction, step 303. Suitable examples of categories for the new job or instruction include, but are not limited to, urgent, business activities, family activities, personal activities, other, and none. In an alternative embodiment, there is no category associated with a job and job creation process 300 may go directly to step 305. At step 305, user 101 selects or adds contact(s) and/or groups of contacts from the user's address book on wireless device 103, step 305. In one embodiment, the address book may be any address book that is accessible by wireless device 103, such as, but not limited to, an address book stored in the cloud, on an email server or one the wireless device. If user 101 chooses, telephone numbers may be manually entered in addition to the contacts entered or selected for the user's address book, step 307. Job creation process 300 determines if user 101 has labeled the instruction or job as urgent at step 309.

If the instruction or job is not urgent, job creation process 300 prompts user 101 to select a date and time at which to send the job from a calendar at step 311. In an alternative embodiment, user 101 may enter the send date and time manually for non-urgent instructions or jobs. If the instruction or job is designated as urgent, the job creation process 300 prompts user 101 to select if the message should be sent immediately at step 323. The response to the prompt is processed by job creation process 300 at decision step 325. If user 101 responds NO, then, user 101 is prompted to select the send date and time from a calendar at step 311.

The job creation process 300 checks for different country codes and area codes of the recipients' telephone numbers that are different from the telephone number of user 101, step 313. Job creation process 300 determines if there are different country codes or area codes for the telephone numbers at step 315. If it is determined that there are different country codes or area codes for the recipients' telephone numbers, job creation process 300 queries user 101 if an auto adjust is desired to send audio file 105 between a specific time window, such as, but not limited to, 8 am-8 pm at step 317. In an alternative embodiment, job creation process 300 may use any time designation or window specified by user 101, such as a user-specified delivery time for the recipient having a telephone number with a different country code or area code than user's telephone number. Job creation process 300 processes the user response regarding auto adjusting at step 319. If user 101 instructs job creation process 300 to auto adjust, the corresponding job or instruction is updated with an auto adjust indicator for the recipients' telephone numbers having different country codes or area codes at step 321. Job creation process 300 then saves the telephone list, including any telephone numbers that have been flagged for auto adjust and allows user 101 to record or upload audio file 105 at step 327.

At step 309, if user 101 has categorized the job or instruction as urgent and user 101 has selected that the instruction or job should be sent immediately, steps 323 and 325, then user 101 is able to save the telephone list and record or upload audio file 105 at step 327. Job creation process 300 allows user 101 to record a message, playback a message for review, delete a message or re-record a message at step 329. User 101 instructs job or instruction creation process 300 by selecting “submit” to send the message, or by selecting “cancel” to review the message at step 331. Selection is done in any suitable means based on the device that user 101 is using to interface with audio file delivery system 100, such as but not limited to, by making a conventional mouse click, if using a mouse, or tapping a touch screen if device has touch screen, or using voice commands. If user 101 selects “cancel,” job creation process 300 prompts user 101 if the instruction or job should be deleted, if user 101 wants to add or edit recipients of the message, or if user 101 wants to re-record the message, step 333. If user 101 selects “submit” the job creation process 300 attempts to establish a connection to application server 113, step 335. If a connection to application server 113 cannot be established, audio file 105 and recipient telephone list are saved to wireless device 103 for the next time a connection to application server 113 can be established at step 337. Additionally, job creation process 300 informs user 101 if there is no current connection to application server 113, at step 337. Once connection to application server 113 is established, the instruction or job is submitted to application server 113 (see FIG. 1) for processing at step 339.

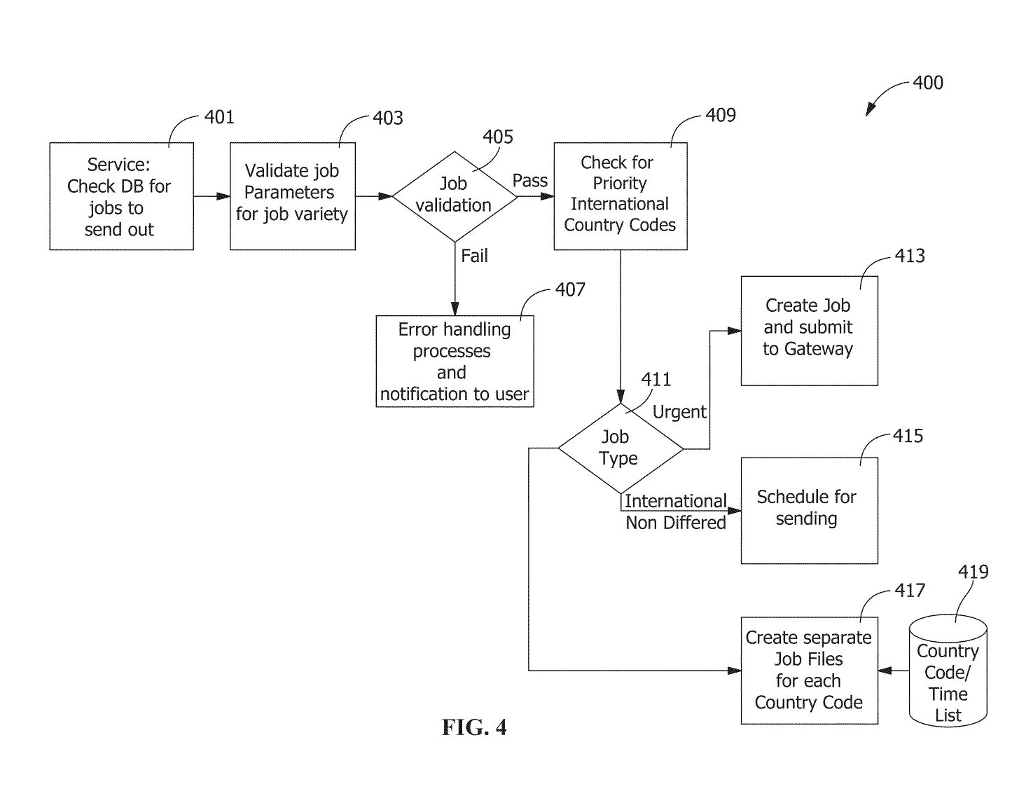

According to one embodiment, the audio file or voice message delivery system 100 includes a job execution process. FIG. 4 is a schematic block diagram of a job execution process 400 in accordance with an exemplary embodiment. Job execution process 400 includes querying the database in application server 113 for jobs or instructions created by the job creation process 300 (see FIG. 3) at step 401. Job execution process 400 verifies the job or instruction parameters to determine if it is a valid job, step 403. Job execution process 400 validates the job or instruction at step 405. At step 405, if the job validation fails, an error handling process is initiated and a notification transmitted to user 101 at step 407. At step 405, if the job is valid, then job execution process 400 checks the job or instruction for any priority designation (e.g., an urgent designation) at step 409. Additionally, if job is valid at step 409, job execution process 400 checks recipient phone numbers for international country codes or area codes that are different than that of the user's phone number at step 409. Job execution process 400 creates a job type at step 411. If the job or instruction is designated as urgent, the instruction or job is submitted to telecom gateway 115 to be sent to the designated recipients at step 413. If the job or instruction includes a non-flagged international number, the instruction or job is transmitted by telecom gateway 115 at step 415. If the job or instruction includes a “flagged” international number or different area code then job execution process 400 creates separate job or instruction file for each country code or area code in each of the recipient's telephone numbers at step 417. A country code/area code time list is used to determine what time the “flagged” instruction or job should be sent at step 419.

After telecom gateway 115 transmits the audio file or message, a report 117 is generated for user 101. Report 117 provides user 101 with message verification data, e.g., that the recipients received the audio file or voice message. Report 117 also indicates whether the audio file or message was not delivered to the designated recipients and details such as which recipients did not receive audio file 105, and results and times of subsequent attempts to re-send audio file 105. In another embodiment, software application indicates whether the audio file or message was received by a human or a machine, e.g., voicemail of recipient. As shown in FIG. 1, report 117 is automatically transmitted to user 101, e.g., via email or other automated messaging service.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An audio file delivery system comprising:
a recording device operable to record an audio file;
a wireless device having internet connectivity;
a job creation process operable to receive instructions from the wireless device and communicate with a server, the job creation process including a new job operable to receive the audio file;
a job execution process to execute instructions on the server from the new job created in the job creation process;
a telecom gateway that receives input from the server to send the audio file to at least one recipient telephone number; and
an email verification, wherein the email verification is provided by the server and sent to a user indicating that the audio file was received by a recipient.

2. The audio file delivery system of claim 1, wherein the wireless device and the recording device are a single device.

3. The audio file delivery system of claim 1, wherein the recording device is selected from the group comprising digital recorders, microphones, landline telephones, desktop computers, and combinations thereof.

4. The audio file delivery system of claim 1, wherein the new job is categorized.

5. The audio file delivery system of claim 1, wherein the job creation process accepts the at least one recipient phone number from the user, the at least one recipient phone number having a country code, an area code or a combination thereof.

6. The audio file delivery system of claim 5, wherein the job creation process compares the at least one recipient phone number to a user phone number and if there is a difference between the country code, area code or both, the job creation process generates a query and flags the at least one recipient phone number.

7. The audio file delivery system of claim 6, wherein the query prompts the user to auto adjust a send time of the audio file based on the country code or area code of the at least one recipient phone number.

8. The audio file delivery system of claim 4, wherein the job execution process verifies parameters of the new job at a validation step, and if the validation step fails, then the job execution process transmits an error message to the user, or if the validation step passes, then the job execution process checks to see if the new job is categorized.

9. The audio file delivery system of claim 6, wherein the job execution process searches for the flags on the at least one recipient phone number.

10. The audio file delivery system of claim 6, wherein if at least one recipient phone number includes a flag, the job execution process creates a separate job file for each different country code or area code that differs from the user phone number.

11. The audio file delivery system of claim 7, wherein the country code or area code is compared to a list to determine a new time for the auto adjust to send the new job including the audio file.

12. A method of delivering an audio file, the method comprising;
recording the audio file using a recording device;
providing a wireless device having internet connectivity;
accessing a job creation process with the wireless device, the job creation process being operable to receive instructions from the wireless device and communicate with a server, the job creation process including a new job operable to receive the audio file;
uploading the audio file to the new job;
entering at least one recipient phone number on the wireless device, wherein the at least one recipient phone number is associated with the new job;
running a job execution process, the job execution process being operable to execute instructions on the server from the new job created in the job creation process;
sending the instructions and the new job from the server to a telecom gateway, the telecom gateway being operable to receive input from the server to send the audio file to the at least one recipient telephone number;
sending the audio file to the at least one recipient telephone number through the telecom gateway; and
generating a report verifying delivery of the audio file to the at least one recipient telephone number.

13. The method of claim 12, further including, after the step of generating, of delivering the report to the wireless device.

14. The method of claim 12, wherein the step of accessing further includes a step of categorizing the new job.

15. The method of claim 12, wherein the at least one recipient phone number includes country code or an area code, and wherein the method further includes a step of comparing, after the step of accessing but prior to the step up uploading, wherein the comparing step includes comparing the at least one recipient phone number to a user phone number and if a difference is determined between the country code, the area code, or both, the job creation process generates a query and flags the at least one recipient phone number.

16. The method of claim 15 further including, prior to the step of uploading the audio file, wherein if at least one recipient phone number includes a flag, then the method further includes a step of creating a separate job file for each country code or area code of the at least one recipient phone number that differs from the user phone number.

17. A method of delivering an audio file, the method comprising;
providing a wireless device having internet connectivity, the wireless device being operable to record and store the audio file;
recording and storing the audio file on the wireless device;
accessing a job creation process with the wireless device, the job creation process being operable to receive instructions from the wireless device and communicate with a server, the job creation process including a new job;
uploading the audio file to the new job;
entering at least one recipient phone number on the wireless device, wherein the at least one recipient phone number is associated with the new job;
running a job execution process, the job execution process being operable to execute instructions on the server from the new job created in the job creation process;
sending the instructions and the new job from the server to a telecom gateway, the telecom gateway being operable to receive input from the server to send the audio file to the at least one recipient telephone number;
sending the audio file to the at least one recipient telephone number through the telecom gateway; and
generating a report verifying delivery of the audio file to the at least one recipient telephone number.

18. The method of claim 17, wherein the step of accessing further includes a step of categorizing the new job.

19. The method of claim 17, wherein the at least one recipient phone number includes country code and an area code, and wherein the method further includes a step of comparing, after the step of accessing but prior to the step up uploading, wherein the comparing step includes comparing the at least one recipient phone number to a user phone number and if a difference is determined between the country code, the area code, or both, the job creation process generates a query and flags the at least one recipient phone number.

20. The method of claim 19 further including, prior to the step of uploading the audio file, wherein if at least one recipient phone number includes a flag, then the method further includes a step of creating a separate job file for each country code or area code of the at least one recipient phone number that differs from the user phone number.
